(19) United States
(12) Patent Application Publication
(10) Pub. No.: US 2026/0324679 A1
(43) Pub. Date: Oct. 22, 2026

(54) EDIBLE RAPESEED PROTEIN WITH HIGH FOAMING PROPERTY AND PREPARATION METHOD AND USE THEREOF

(71) Applicant: OIL CROPS RESEARCH INSTITUTE, CHINESE ACADEMY OF AGRICULTURAL SCIENCES, WUHAN (CN)

(72) Inventors: DENGFENG PENG, WUHAN (CN); QIANCHUN DENG, WUHAN (CN); JINGJING WANG, WUHAN (CN); FENGHONG HUANG, WUHAN (CN); XIA WAN, WUHAN (CN); WEIPING JIN, WUHAN (CN); XIA XIANG, WUHAN (CN); YASHU CHEN, WUHAN (CN); ZIYU DENG, WUHAN (CN); CHANG ZHENG, WUHAN (CN)

(21) Appl. No.: 19/641,707

(22) Filed: Apr. 8, 2026

(30) Foreign Application Priority Data
Apr. 16, 2025 (CN) 202510475585.0

(51) Int. Cl. A23J 3/14

(52) U.S. Cl. CPC A23J 3/14

(57) ABSTRACT

An edible rapeseed protein with high foaming property, and a preparation method and a use thereof are provided. In the preparation method, through the primary acidic control together with the stepwise ultrafiltration concentration process under a weakly acidic condition (with a pH of 5.0~7.0), a high-concentration rapeseed protein solution (with a protein concentration of ≥6%) is obtained; a secondary acidic control regulates the structure of the rapeseed protein under an acidic condition (pH 2.0~4.0), and is coupled with a physical field treatment such as ultrasonic and infrared treatment, to penetrate deep into the internal regions of the protein structure through actions such as cavitation, shearing, and thermal effect, alter its surface charge, hydrophobicity, and other structural properties, and affect the interaction between polyphenols and protein; and finally, the pH is cycled to neutral, causing the protein to reassemble into controllable aggregates.

### CROSS REFERENCE TO RELATED APPLICATIONS

The present disclosure claims the priority to the Chinese patent application with the filing No. 202510475585.0, entitled “EDIBLE RAPESEED PROTEIN WITH HIGH FOAMING PROPERTY AND PREPARATION METHOD AND USE THEREOF” and filed on Apr. 16, 2025 with the Chinese Patent Office, the contents of which are incorporated herein by reference in their entirety.

### TECHNICAL FIELD

The present disclosure belongs to the technical field of plant protein extraction, and particularly relates to an edible rapeseed protein with high foaming property, and a preparation method and a use thereof.

### BACKGROUND ART

A challenge facing the agricultural food sector is meeting the ever-growing global demand for protein while maintaining sustainable development. Due to the effect of animal protein on the carbon-nitrogen cycle and biodiversity, substantial environmental pressure is generated, and thus the excessive utilization of animal protein is incompatible with the concept of sustainable development. In addition, a high proportion of animal protein intake may lead to several health problems, including an increased risk of obesity, type 2 diabetes, and cardiovascular disease. Therefore, it is an essential prerequisite for feeding the projected global population of 10 billion by 2050 to seek alternatives to animal protein, such as plant, insect, fungal and microbial proteins. Among these, plant protein stands out as the most ideal choice, considering the established supply chains and consumer acceptance of the above bio-based protein sources, and their proven nutritional value and sustainability.

Rapeseed is the world's second most widely cultivated oilseed crop after soybeans. In 2023-2024, the annual rapeseed production of China reached 16.3174 million tons, making it one of the most important oilseed crops in China and simultaneously one of the major sources of oil supply in China. Cake or meal is a byproduct of rapeseed oil extraction. According to statistics from the U.S. Department of Agriculture, China consumed approximately 11 million tons of rapeseed cake or meal in 2019-2020, accounting for one-third of global consumption. Rapeseed cake or meal is typically used as animal feed or agricultural fertilizer and has low economic benefits. However, rapeseed cake or meal is rich in crude protein (content of ~40%), and rapeseed protein has the advantages such as balanced amino acid composition, a high nutritional value, and excellent functional properties, making it a promising new source of plant protein. Therefore, preparing edible rapeseed protein from rapeseed cake or meal to increase its added value has significant social and economic benefits, and contributes to the sustainable development of the rapeseed planting industry.

However, due to the complex composition of rapeseed cake or meal, the presence of a large number of anti-nutritional factors (such as phenolic substances, glucosinolates, phytic acid, etc.) that are tightly bound to proteins, and the significant differences in the physicochemical properties of the main protein fractions (mainly 11S cruciferin and 2S napin) of the rapeseed cake or meal, technologies commonly used for plant protein extraction at present, such as the alkali dissolution-acid precipitation method, are not suitable for preparing edible rapeseed protein isolate from rapeseed cake or meal. Prior research has found that rapeseed protein isolate has high foaming property, which is superior to those of whey protein isolate and soy protein isolate, making it a promising biomacromolecule-based foaming agent with high application potential in the food field; however, prior extraction methods such as alkali dissolution-acid precipitation method may lead to uncontrollable aggregation of rapeseed protein and the formation of large aggregates, thus preventing its foaming property from being fully expressed. Therefore, it is of great significance to break through a preparation technique for an edible rapeseed protein isolate with high foaming property by combining resource advantages of the rapeseed and the high nutritional value and foaming property of the rapeseed protein.

### SUMMARY

In view of this, in order to solve the problems existing in the prior art, the present disclosure improves an obtained preparation method for rapeseed protein for which the glucosinolate and phytic acid contents meet the European Union standards for edible rapeseed protein, where the rapeseed protein extract is subjected to a “gradient-acidic to neutral” pH cycle treatment, which not only avoids the irreversible denaturation of protein that may be caused by a single pH cycle technique, but also achieves dynamic and ordered regulation of structural properties such as surface charge and surface hydrophobicity of the protein, and the interaction between proteins and polyphenols can be also regulated orderedly, ultimately realizing the structural modification, functional property enhancement and color improvement of high-concentration rapeseed protein.

To achieve the above purposes, the present disclosure adopts the following technical solutions:
a preparation method for an edible rapeseed protein with high foaming property, including performing “gradient-acidic to neutral” pH cycle treatment on a rapeseed protein extract, which is coupled with membrane separation and physical field modification technique to achieve structural modification and quality improvement of the high-concentration rapeseed protein.

Further, the preparation method includes obtaining the rapeseed protein extract by using a technique in which an appropriate-concentration salt solution and directional sieving are synchronously used; then performing primary acidic control coupled with stepwise ultrafiltration concentration (i.e., stepwise ultrafiltration for concentration) to obtain a high-concentration rapeseed protein solution; subsequently, performing secondary acidic control coupled with physical field treatment; and finally readjusting the pH value of the high-concentration protein solution back to neutral (i.e., neutral environment), and freeze-drying to obtain the edible rapeseed protein with high foaming property.

It is worth noting that the protein obtained by prior preparation techniques for edible rapeseed protein exhibits poor functional properties such as solubility and foaming property, failing to meet the use requirements for food foaming agent. For plant proteins of such as soybean, pea, and flaxseed, most pH-shift modification methods adopt shifting under alkaline conditions. However, the alkaline shift or the technique in which alkaline shift is coupled with physical field modification is not applicable to rapeseed protein due to the significant differences in the physicochemical properties of the protein fractions contained in the rapeseed protein and the presence of a large amount of non-protein fractions such as polyphenols; and not only the improvement in functional properties is limited, but also, because the modification process is carried out under the alkaline condition, polyphenols are easily oxidized to quinones, which then covalently bind to the protein, resulting in a darker color and an unsatisfactory appearance of the protein. Furthermore, to avoid irreversible protein denaturation caused by extreme pH, prior pH shifting techniques often employ a single weak acid/weak base shifting treatment, which cannot meet the technical requirements of the complex composition and multiple isoelectric points of plant proteins, and the effect also fails to meet the demands of food industrialization.

In the present disclosure, the rapeseed protein extract is subjected to centrifugation separation after the primary acidic control; the high-concentration protein solution obtained by synergistically performing stepwise ultrafiltration concentration on the supernatant is in a suspended state without sediment, at which point secondary acidic control is carried out, leading to the occurrence of disaggregation and structural unfolding of rapeseed protein; and physical field modification treatment is further coupled under this condition, to further disaggregate the protein through multiple actions such as cavitation, shearing and heating, and penetrate deep into the internal regions of the protein structure, to alter the structural properties of the protein, such as surface charge distribution, sulfhydryl-disulfide bond content, surface hydrophilicity and hydrophobicity, and rigidity/flexibility. Finally, during the process of readjusting the pH environment of the secondary acidic control back to neutral, the protein undergoes reassembly and controllable aggregation, ultimately endowing the rapeseed protein with good surface structural properties to enable it to be adsorbed more rapidly at the air-water interface and form a viscoelastic interfacial film and fully exert the high foaming property of the rapeseed protein.

More further, the pH range of the primary acidic control is 5.0~7.0, and the pH range of the secondary acidic control is 2.0~4.0.

It is worth noting that the pH of the primary acidic control system is set to be 5.0~7.0, mainly based on the consideration that under a weakly acidic condition, glucosinolates are liable to hydrolysis, and the bond between the protein and phytic acid is relatively weak, which is more conducive to protein enrichment and the separation from phytic acid, glucosinolates and other substances; moreover, the weakly acidic environment can avoid the effect of the alkaline condition on polyphenols in the rapeseed protein, and can regulate the interaction between the polyphenols and rapeseed protein and alter the structural properties of the protein, thereby achieving both improved protein yield and enhanced protein quality. The primary acidic control coupled with the stepwise ultrafiltration concentration can not only effectively remove non-protein fractions but also control the degree of protein aggregation, thereby breaking through the concentration limitation of existing rapeseed protein solution to obtain the high-concentration rapeseed protein solution, and enabling the possibility of large-scale preparation of the rapeseed protein with high foaming property.

Furthermore, in the present disclosure, physical field modification treatment is coupled in the secondary acidic control stage for the treatment of high-concentration rapeseed protein solution. First, further control is implemented to enhance the acidity of the system, to adjust the pH of the high-concentration protein solution to acidic (i.e., an acidic environment, pH range of 2.0~4.0), so as to promote the disaggregation/partial disaggregation of rapeseed protein aggregates. At this point, the protein conformation undergoes unfolding and the surface structural properties are altered. Under such condition, ultrasonic and infrared physical field treatment techniques are applied synchronously, so as to cause, through the multiple actions such as cavitation, shearing, and thermal effect introduced by the physical field, the high-concentration rapeseed protein to further disaggregate and penetrate deep into the internal regions of the protein structure to further alter the structural properties of the protein including surface charge distribution, sulfhydryl-disulfide bond content, surface hydrophilicity and hydrophobicity, and rigidity/flexibility. Finally, the pH of the high-concentration rapeseed protein solution is cycled from acidic (an acidic environment) to neutral. At this time, the protein disaggregates undergo reassembly and controllable aggregation, ultimately endowing the rapeseed protein with good surface structural properties, to enable it to be adsorbed more rapidly at the air-water interface and form a viscoelastic interfacial film and fully exert the high foaming property of the rapeseed protein.

In addition, considering that under the alkaline condition, polyphenols are easy to be oxidized to give quinone substances which in turn covalently bind to proteins to result in a deepened protein color and reduced functional properties such as foaming property, the present disclosure, through the “gradient-acidic to neutral” pH cycle treatment, not only avoids the effect of the alkaline condition on polyphenol substances in the rapeseed protein, but also enables the ordered regulation of the interaction between the protein and polyphenols by gradient control of the system pH value, thereby improving the color of the protein.

More further, the physical field modification treatment includes ultrasonic treatment and infrared treatment.

More further, the ultrasonic treatment has a power density of 10-30 W/mL, and is performed for an ultrasonic treatment time of 10-60 min; and the infrared treatment includes a short-wave treatment and a medium-wave treatment, and is performed at a temperature of 80-160 °C for an infrared treatment time of 4-16 min.

It is worth noting that by controlling core parameters such as physical field power and operation time, the structural properties of the protein can be effectively regulated, which is beneficial for leveraging the foaming property of the rapeseed protein. The rapeseed protein prepared by the present disclosure combines ultra-high foaming ability, good foam stability and excellent foam plasticity, where the foaming ability may reach up to 392%, which is higher than that of commonly used plant proteins in the food field such as soybean protein and pea protein, and is also superior to animal foaming agents commonly used in industry, such as ovalbumin and sodium caseinate.

More further, in the technique in which an appropriate-concentration salt solution and directional sieving are synchronously used, the salt solution is a 100 mM calcium chloride or magnesium chloride solution, and the mesh size for the directional sieving is 60-200 mesh.

It is worth noting that since phytic acid may be chelated with divalent metal ions under a weakly acidic condition to obtain rapeseed protein with low phytic acid content, the present disclosure selects one or a combination of more selected from CaCl₂) and MgCl₂ as the good solvent. Considering that the lower the salt concentration of the good solvent is, the lower the difficulty of subsequent desalination is, it is more in line with the concept of green environmental protection. Moreover, the salt ion concentration may affect interactions of protein-protein and protein-other substance, thus influencing protein assembly and aggregation behavior. The low-concentration salt may not only enhance the cavitation and thermal effects brought about by physical fields such as ultrasound and microwaves, but also assist physical fields in regulating protein assembly and aggregation behaviors, affecting structural properties such as protein surface charge distribution and flexibility and altering the interfacial properties of the protein, which is beneficial for improving foaming property. Therefore, the low-concentration salt ions remaining after membrane separation are beneficial for assisting physical fields in regulating protein structure, thereby endowing it with higher foaming property. Furthermore, the higher salt ion concentration not only leads to an increase in the amount of acid used to adjust the pH of the high-concentration rapeseed protein solution after membrane separation, but also cause the occurrence of protein aggregation. Therefore, considering the reduction in the amount of acid used and process operation difficulty, the present disclosure defines that the salt solution is a 100 mM calcium chloride or magnesium chloride solution.

Further, the molecular weight cut-off (MWCO) of the membrane used in the stepwise ultrafiltration concentration is 5-30 kDa, and the protein concentration of the high-concentration rapeseed protein solution is ≥6%.

It is worth noting that in the present disclosure, the stepwise ultrafiltration concentration is coupled in the primary acidic control stage, facilitating the removal of toxic or anti-nutritional substances such as glucosinolates, phytic acid, pigments and polyphenols. By controlling the removal speed of salt ions, the structural properties and aggregation behavior of the protein can be regulated orderedly, which prevents problems of too slow concentration or equipment clogging caused by rapid aggregation and further increases the degree of protein concentration to obtain a high-concentration rapeseed protein solution with a protein concentration of up to 6% or above.

Particularly, the present disclosure applies the membrane separation technique to the stepwise concentration treatment, which on the one hand enables the concentration and purification of the solution of the protein dissolved from rapeseed cake or meal and the removal of toxic or anti-nutritional substances such as glucosinolates, polyphenols and phytic acid, and on the other hand can also effectively control the protein retention size, structural properties and aggregation behavior and improve the yield and quality of the target protein.

The second purpose of the present disclosure is to provide an edible rapeseed protein with high foaming property obtained by the preparation method as described above.

It is worth noting that the edible rapeseed protein with high foaming property obtained by the preparation method disclosed in the present disclosure not only has excellent foaming property, but also produces rapeseed protein with good color without the use of a decolorizing agent. Particularly, the edible rapeseed protein with high foaming property disclosed in the present disclosure has a maximum foaming ability of up to 392%, being higher than that of plant proteins like soy protein, 3.1 times that of the commonly used industrial foaming agent ovalbumin and 2.1 times that of sodium caseinate; and produces dense foam with excellent plasticity during use and thus has the potential to serve as an egg white substitute.

Furthermore, the third purpose of the present disclosure is to provide a use of the above-described edible rapeseed protein with high foaming property as a protein ingredient and a foaming agent in the food field.

It is worth noting that the foaming agent is an important formulation in the food field. Commonly used protein foaming agents, such as whey protein and ovalbumin, are mainly animal proteins, which are difficult to meet the development demands of diversified products. Therefore, it is of great significance to explore plant protein-based foaming agents. Prior researches report that rapeseed protein has high foaming property and is a plant protein-based foaming agent with a great application potential in the food field; however, due to its poor color and high anti-nutritional factor content, it is not conducive to edible use, and the prior preparation processes fail to fully exploit its foaming property. The present disclosure improves its color, reduces its anti-nutritional factor content, and improves its foaming ability, prepares an edible rapeseed protein with high foaming property, and applies it as a food ingredient and foaming agent in the food field.

Addressing the issues of multi-fraction composition, wide isoelectric point range, and great influence from non-protein fractions in rapeseed protein, compared with the prior art, the preparation method for an edible rapeseed protein with high foaming property disclosed in the present disclosure utilizes the “gradient-acidic to neutral” pH cycle treatment technique coupled with membrane separation and physical field modification techniques under the control of gradient pH to orderedly regulate the structural properties of protein, such as charge, size, and surface hydrophobicity, which not only breaks through the concentration limitations of traditional rapeseed protein solutions, but also achieves structural modification and functional property enhancement of the high-concentration rapeseed protein.

In the above, the rapeseed protein extract obtained by technique in which an appropriate-concentration salt solution and directional sieving are synchronously used is further treated by the primary acidic control coupled with the stepwise ultrafiltration concentration, where the stepwise ultrafiltration under a weakly acidic condition (with a pH range of 5.0~7.0) facilitates the removal of small-molecule substances such as glucosinolates and phytic acid, and can also control protein structure properties and aggregation behavior to obtain a high-concentration rapeseed protein solution with a protein concentration of ≥6%. The secondary acidic control is coupled with physical field modification treatment to further acidify and modify the high-concentration rapeseed protein solution under an acidic condition (with a pH range of 2.0~4.0), which on the one hand, avoids the effect of the alkaline condition on polyphenol substances in rapeseed protein, and on the other hand, penetrates into the internal structure of the protein through actions such as cavitation, shearing and heating, to further disaggregate the high-concentration protein and inducing changes in surface structure. Finally, the process of readjusting the pH back to neutral induces the self-assembly of the protein to form aggregates, ultimately endowing the rapeseed protein with high foaming property. The obtained edible rapeseed protein with high foaming property has a maximum foaming ability of up to 392%, which is higher than that of plant proteins like soy protein, 3.1 times that of the commonly used industrial foaming agent ovalbumin and 2.1 times that of sodium caseinate; and produces dense foam with excellent plasticity during use and thus has the potential to serve as an egg white substitute.

### BRIEF DESCRIPTION OF DRAWINGS

To more clearly illustrate the technical solutions in the embodiments of the present disclosure or in the prior art, the drawings required for use in the description of the embodiments or the prior art will be briefly introduced below. Obviously, the drawings described below are only embodiments of the present disclosure. For those ordinarily skilled in the art, other drawings may be obtained based on the provided drawings without creative effort.

FIG. 1 is a schematic flowchart of the preparation for an edible rapeseed protein with high foaming property of the present disclosure.

FIG. 2 is a macroscopic view of the foam plasticity of rapeseed proteins prepared in Comparative Examples 1-2 and Example 2 of the present disclosure.

FIG. 3 shows the zeta potentials of rapeseed proteins prepared in Comparative Examples 1-3 and Example 2 of the present disclosure.

FIG. 4 shows the surface hydrophobicity of rapeseed proteins prepared in Comparative Examples 1-3 and Example 2 of the present disclosure.

FIG. 5 shows the average particle size of rapeseed proteins prepared in Comparative Examples 1-3 and Example 2 of the present disclosure.

FIG. 6 is the particle size distribution view of rapeseed proteins prepared in Comparative Examples 1-3 and Example 2 of the present disclosure.

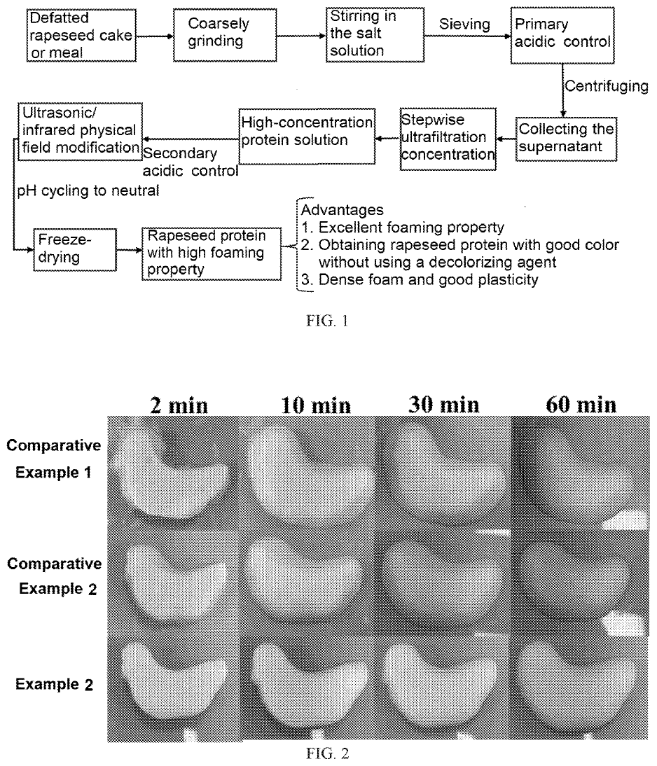

### DETAILED DESCRIPTION OF EMBODIMENTS

The technical solutions in the embodiments of the present disclosure will be clearly and completely described below. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

For the specific term “embodiment” used herein, any examples described as “exemplary” should not necessarily be construed as superior or better than other embodiments. Performance index testing in the embodiments of the present disclosure, unless otherwise specified, employs conventional testing methods in the art. It should be understood that the terms used in the present disclosure are merely for describing specific implementations and are not intended to limit the content of the present disclosure.

Unless otherwise stated, the technical and scientific terms used herein have the same meaning as commonly understood by a person of ordinary skill in the art to which the present disclosure belongs; and unless otherwise specified, other experimental methods and technical means in the present disclosure all refer to experimental methods and technical means commonly used by a person of ordinary skill in the art.

To better illustrate the content of the present disclosure, numerous specific details are provided in the following embodiments. Those skilled in the art should understand that the present disclosure may also be implemented even without certain specific details. In the embodiments, some methods, means, instruments, and devices well-known to those skilled in the art are not described in detail in order to highlight the main points of the present disclosure.

Without conflict, the technical features disclosed in the embodiments of the present disclosure may be combined arbitrarily, and the obtained technical solutions belong to the content disclosed by the embodiments of the present disclosure.

The present disclosure discloses an edible rapeseed protein with high foaming property, and a preparation method and a use thereof, belonging to the technical field of plant protein extraction. The present disclosure first employs a technique in which an appropriate-concentration salt solution and directional sieving are synchronously used, to obtain a rapeseed protein extract, and then utilizes an “gradient-acidic to neutral” pH cycle treatment technique coupled with membrane separation and physical field modification techniques under the control of gradient pH, where through the primary acidic control together with the stepwise ultrafiltration concentration process under a weakly acidic condition (with a pH of 5.0~7.0), a high-concentration rapeseed protein solution (with a protein concentration of ≥6%) is obtained; the secondary acidic control is coupled with a physical field modification treatment, namely orderly regulation is performed under an acidic condition (i.e., a pH range of 2.0-4.0) to induce the disaggregation of rapeseed protein and the unfolding of protein conformation, and at this point, the physical field treatment such as ultrasonic and infrared treatment is coupled, to penetrate into the internal regions of the protein structure through the actions such as cavitation, shearing, and thermal effect, alter its structural properties including surface charge distribution and hydrophobicity, and affect the interaction between polyphenols and proteins; and finally, the process of cycling the pH back to neutral enables the protein to reassemble into controllable aggregates, ultimately endowing the rapeseed protein with high foaming property and good color.

To better understand the present disclosure, the following embodiments are provided below for further detailed description of the present disclosure, but should not be construed as limiting the present disclosure. Any non-essential improvements and adjustments made by those skilled in the art based on the above-described disclosure are also considered to fall within the protection scope of the present disclosure.

The rapeseed variety used in the following Examples and Comparative Examples was Qinyou 1718, from Anhui in China.

The experimental methods used in the following Examples and Comparative Examples were as follows.

### Determination of Protein Content

The protein contents of rapeseed proteins obtained in Examples and Comparative Examples were determined by the Kjeldahl method, specifically according to GB 5009.5-2010 in China, with a protein conversion factor of 5.53.

### Determination of Protein Whiteness Value

The measurement was performed by using a CR-410 colorimeter. Calibration was performed by using a standard white plate before sample measurement. Color parameters were expressed as L* (lightness), a* (red/green), and b* (yellow/blue) values. The whiteness value (WI) of the protein was calculated by using the following formula:

WI=100−²\sqrt{(100−L*)²+(a*)²+(b*)²}

### Determination of Glucosinolate Content

High performance liquid chromatography method was used, specifically referring to NY/T1582-2007 in China.

Phytic acid content detection: dispersing 0.05 g of protein sample into 2 mL of 2.4 wt % hydrochloric acid, stirring for 1 h, then centrifuging at 5000 g for 15 min, adding 0.1 g of NaCl to the supernatant and stirring until dissolved, standing at a low temperature for 1 h, and then centrifuging at 5000 g for 15 min; taking 0.5 mL of the centrifuged supernatant and adding 4.5 mL of deionized water and 4.0 mL of color developing solution sequentially; standing for 20 min, and then measuring the light absorption value at a wavelength of 500 nm. Ferric chloride-sulfosalicylic acid color developing solution was obtained by mixing 0.03% ferric chloride hexahydrate and 0.3% 5-sulfosalicylic acid dihydrate well. A standard curve was plotted by using sodium phytate as a standard.

### Analysis of the Functional Properties of the Protein

### (1) Determination of Foaming Ability and Foam Stability:

preparing a 1% (w/v) rapeseed protein solution, transferring 15 mL of the protein solution into a specially designed cylindrical glass vessel and stirring at 13800 g for 2 min by using an IKA high-speed homogenizer; and after the stirring, measuring the foam height at 2 min and 60 min with a ruler and calculating the foam volumes, recorded as V₂ and V₆₀ respectively, and determining the foaming ability (FA) and foam stability (FS) of the rapeseed protein by using the following formulae.

FA (%)=V₂/15×100

FS (%)=V₆₀/V₂×100

In the above, V₂ indicated the foam volume at 2 min and V₆₀ indicated the foam volume at 60 min.

### (2) Characterization of Foam Plasticity:

preparing a 1% (w/v) rapeseed protein solution, whisking to foam with an egg beater, then setting in a mold for shaping, and recording the change in the foam shape over time.

### Protein Structure Characterization

### (1) Surface Hydrophobicity:

measuring according to the method reported by Peng et al. in their study “Foams Stabilized by B-Lactoglobulin Amyloid Fibrils: Effect of pH”.

### (2) Particle Size and Zeta Potential:

controlling the sample solution concentration at 1 mg/mL, and measuring the zeta potential of the solution by using a nanoparticle size analyzer (ZetaSizer Nano-ZS, Malvern Instruments Limited, UK); and controlling the sample solution concentration at 10 mg/mL, and measuring the particle size of the solution by using a laser particle size analyzer.

Note: the solution pHs are both ~7.0 in (1)~(2) of protein structure characterization.

### Sample Pretreatment:

pressing the rapeseed at a low temperature to obtain a low-temperature pressed rapeseed cake (residual oil content <10%), and performing subcritical fluid extraction degreasing treatment on the rapeseed cake to obtain a defatted rapeseed meal (residual oil content <0.3%).

### Example 1

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product (i.e., the matter that is left on the sieve and does not pass through the sieve) was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (i.e., stepwise membrane separation for concentration, Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 3.0 and then was subjected to an ice bath ultrasonic treatment, with the ultrasonic power density set at 20 W/mL and the ultrasonic time at 30 min, and the pH of the solution was adjusted back to 7.0 after the ultrasonic treatment, and freeze-dried for 72 h to obtain a rapeseed protein isolate, thereby completing Example 1.

### Example 2

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 3.0 and then was subjected to an ice bath ultrasonic treatment, with the ultrasonic power density set at 10 W/mL and the ultrasonic time at 60 min, and the pH of the solution was adjusted back to 7.0 after the ultrasonic treatment, and freeze-dried for 72 h to obtain a rapeseed protein isolate, thereby completing Example 2.

### Example 3

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 3.0 and then was subjected to an ice bath ultrasonic treatment, with the ultrasonic power density set at 30 W/mL and the ultrasonic time at 10 min, and the pH of the solution was adjusted back to 7.0 after the ultrasonic treatment, and freeze-dried for 72 h to obtain a rapeseed protein isolate, thereby completing Example 3.

### Example 4

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate the protein concentration of ≥6% to obtain a high-concentration rapeseed protein solution. The high-concentration protein solution underwent secondary pH adjustment to make the pH stabilized at 4.0 and was subjected to an ice bath ultrasonic treatment, with the ultrasonic power density set at 20 W/mL and the ultrasonic time at 30 min, and the pH of the solution was adjusted back to 7.0 after the ultrasonic treatment, and freeze-dried for 72 h to obtain a rapeseed protein isolate, thereby completing Example 4.

### Example 5

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrating the protein concentration of ≥6% to obtain a high-concentration rapeseed protein solution. The high-concentration protein solution underwent secondary pH adjustment to make the pH stabilized at 3.0 and then was subjected to an infrared treatment at a short wavelength and 80 °C for a time of 16 min, and the pH of the solution was adjusted back to 7.0 after the infrared treatment and freeze-dried for 72 h to obtain a rapeseed protein isolate, thereby completing Example 5.

### Example 6

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 3.0 and then was subjected to an infrared treatment at a short wavelength and 160 °C for a time of 4 min, and the pH of the solution was adjusted back to 7.0 after the infrared treatment and freeze-dried for 72 h to obtain a rapeseed protein isolate, thereby completing Example 6.

### Example 7

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 2.0 and was then subjected to an infrared treatment at a medium wavelength and 120 °C for 8 min, and the pH of the solution was adjusted back to 7.0 after the infrared treatment and freeze-dried for 72 h to obtain a rapeseed protein isolate, thereby completing Example 7.

To further demonstrate the beneficial effects of the present disclosure to better understand the present disclosure, the properties and use performances of the edible rapeseed protein with high foaming property and a preparation method thereof disclosed in the present disclosure are further illustrated below through the following Comparative Examples and Experimental Examples. However, these should not be construed as limiting the present disclosure. Methods and their properties derived from other determination experiments conducted by those skilled in the art on the basis of the above-described invention content, and the uses implemented according to the aforesaid properties, shall also be considered to fall within the protection scope of the present disclosure.

### Comparative Example 1

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution was adjusted to the pH of 7.0 and freeze-dried for 72 h to obtain a rapeseed protein isolate, thereby completing Comparative Example 1.

### Comparative Example 2

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 10.0 and then was subjected to an ice bath ultrasonic treatment, with the ultrasonic power density set at 10 W/mL and the ultrasonic time at 60 min, and the pH of the solution was adjusted back to 7.0 after the ultrasonic treatment, and freeze-dried for 72 h to obtain a rapeseed protein isolate, thereby completing Comparative Example 2.

### Comparative Example 3

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 3.0, and then the pH of the solution was adjusted back to 7.0 and freeze-dried for 72 h to obtain a rapeseed protein isolate, thereby completing Comparative Example 3.

### Comparative Example 4

The defatted rapeseed meal was coarsely ground in a mortar, and then dispersed in a 100 mM calcium chloride aqueous solution at a ratio of 1:8 (w/v), stirred at a room temperature (25 °C) for 30 min, and sieved through a 200-mesh sieve, and then the oversize product was washed with an equal volume of the calcium chloride aqueous solution to obtain a rapeseed protein extract. Then the extract underwent primary adjustment to the pH of 5.8 with HCl, stirred at a room temperature for 60 min, and then centrifuged at 10000 g for 30 min, and the supernatant was collected and then transferred to the sample chamber of a membrane separation device, and the solution was concentrated and purified by using a stepwise membrane separation concentration method (Hydrosart® membrane of MWCO 10 kDa), to concentrate to the protein concentration of ≥6% to obtain a high-concentration rapeseed protein solution. The high-concentration protein solution underwent secondary pH adjustment to make the pH stabilized at 10.0, and then was subjected to an infrared treatment at a short wavelength and 160 °C for a time of 4 min, and the pH of the solution was adjusted back to 7.0 after the infrared treatment and freeze-dried for 72 h to obtain a rapeseed protein isolate, thereby achieving Comparative Example 4.

### Experimental Example 1

The protein contents of the rapeseed proteins obtained in Examples 1-7 were all at a relatively high level; and when the protein conversion factor was 5.53, the protein contents were all around 81%, which met the requirements for concentrated protein or isolated protein in commercially available protein products in China. Furthermore, after converting the data by using a conversion factor of 6.25, the protein contents of Examples 1-7 were about 92%, and the data may be used for comparison with the protein contents of related products from abroad.

The glucosinolate and phytic acid contents of the rapeseed proteins in Examples 1-2 were tested, and it was obtained that the glucosinolate content was about 0.87 μmol/g, and the phytic acid content was about 0.78%. Both contents met the European Union COMMISSION IMPLEMENTING DECISION of 1 Jul. 2014 for glucosinolate (≤1 μmol/g) and phytic acid (≤1.5%) in edible rapeseed protein.

### Experimental Example 2

The foaming ability, foam stability and foam plasticity of the rapeseed proteins obtained in Examples 1-7 and Comparative Examples 1~4 were compared. The results were as shown in Table 2 and FIG. 2.

TABLE 1
Foaming Ability and Foam Stability of Rapeseed Proteins
Obtained in Examples 1-7 and Comparative Examples 1-4

| | Foaming Ability/% | Foam Stability/% |
|---|---|---|
| Comparative Example 1 | 209.90 ± 4.60 | 78.30 ± 1.72 |
| Comparative Example 2 | 326.89 ± 8.04 | 73.77 ± 0.17 |
| Comparative Example 3 | 328.68 ± 3.34 | 65.92 ± 0.56 |
| Comparative Example 4 | 239.37 ± 15.37 | 51.02 ± 2.27 |
| Example 1 | 392.10 ± 8.84 | 80.90 ± 2.10 |
| Example 2 | 384.06 ± 10.79 | 76.73 ± 4.36 |
| Example 3 | 384.06 ± 6.68 | 76.78 ± 2.96 |
| Example 4 | 345.65 ± 2.68 | 77.52 ± 0.17 |
| Example 5 | 391.20 ± 13.66 | 76.95 ± 2.61 |
| Example 6 | 389.42 ± 12.63 | 76.39 ± 0.78 |
| Example 7 | 329.57 ± 5.79 | 71.27 ± 1.43 |

As shown in Table 1, the foaming ability of the rapeseed protein obtained in Examples 1-7 is all greater than 329%, with the highest reaching 392%. Compared with Comparative Example 1 (~210%), the foaming ability of Examples 1-7 is significantly improved, proving that the “gradient-acidic to neutral” pH cycle treatment coupled with membrane separation and physical field modification techniques has a significant technical effect on improving the foaming ability of the rapeseed proteins. In the above, Example 2 and Comparative Example 2 have the same ultrasonic treatment parameters, and are only different in the pH of the cycle; Example 6 and Comparative Example 4 have the same infrared treatment parameters, and are only different in the pH of the cycle; Example 2 and Example 6 use a gradient-acidic (weakly acidic→acidic) to neutral cycle, while Comparative Example 2 and Comparative Example 4 use an acidic-alkaline-neutral adjustment. As known from comparison of Example 2 (foaming ability ~384%, foam stability ~77%) and Example 6 (foaming ability ~389%, foam stability ~76%) with Comparative Example 2 (foaming ability ~327%, foam stability ~74%) and Comparative Example 4 (foaming ability ~239%, foam stability ~51%), gradient-acidic to neutral cycle coupled with physical field modification can achieve dynamic and orderly regulation of structural properties such as charge and surface hydrophobicity of the protein, and can further orderedly regulate the interaction between protein and polyphenols; and thus, the technical effect on the foaming ability and foam stability is significantly better than that of the acidic-alkaline-neutral adjustment coupled with physical field modification. The foaming ability of Examples 1-3 and Example 5 is all greater than 384%, and the foam stability is all greater than 77%. By comparing them with Comparative Example 3 (foaming ability ~329%, foam stability ~66%), it is found that on the basis of gradient-acidic to neutral cycle, the foaming property of the rapeseed protein is further significantly improved by further being coupled with physical field treatment.

In addition, as can be seen from FIG. 2, the foam plasticity (referring to the ability of the foam to maintain a certain shape herein) of Example 2 is significantly better than that of Comparative Example 1 and Comparative Example 2, indicating that gradient-acidic to neutral cycle coupled with a physical field treatment can further impart good foam plasticity to the rapeseed protein. In summary, only by coupling the gradient-acidic to neutral cycle with the physical field can the rapeseed protein possess ultra-high foaming ability, good foam stability, and excellent foam plasticity, thereby significantly expanding the application range of the rapeseed protein as a plant-based foaming agent in the food field.

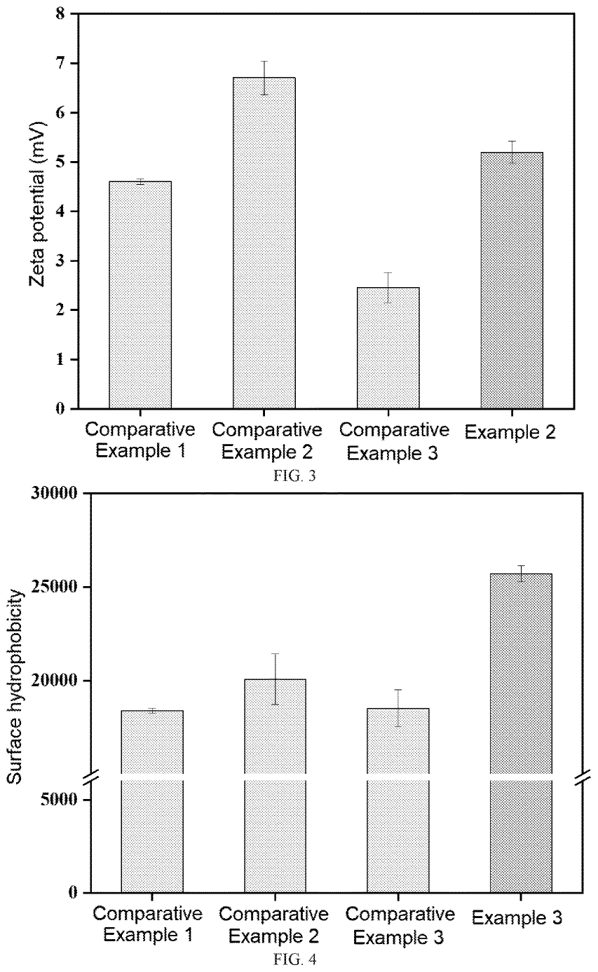

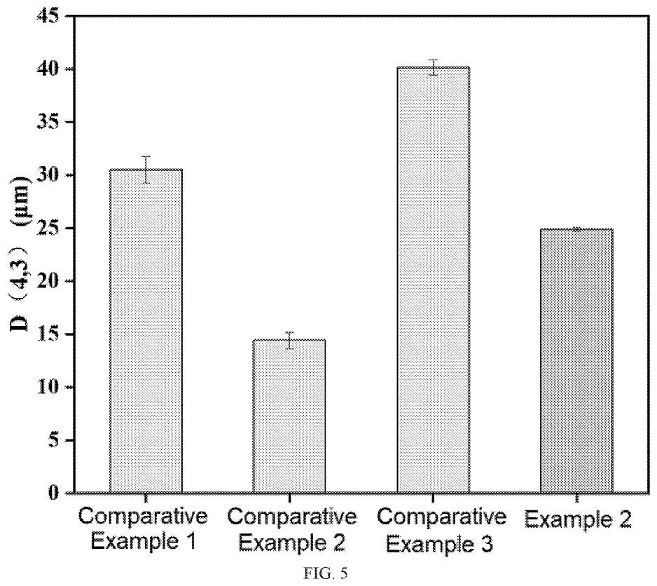

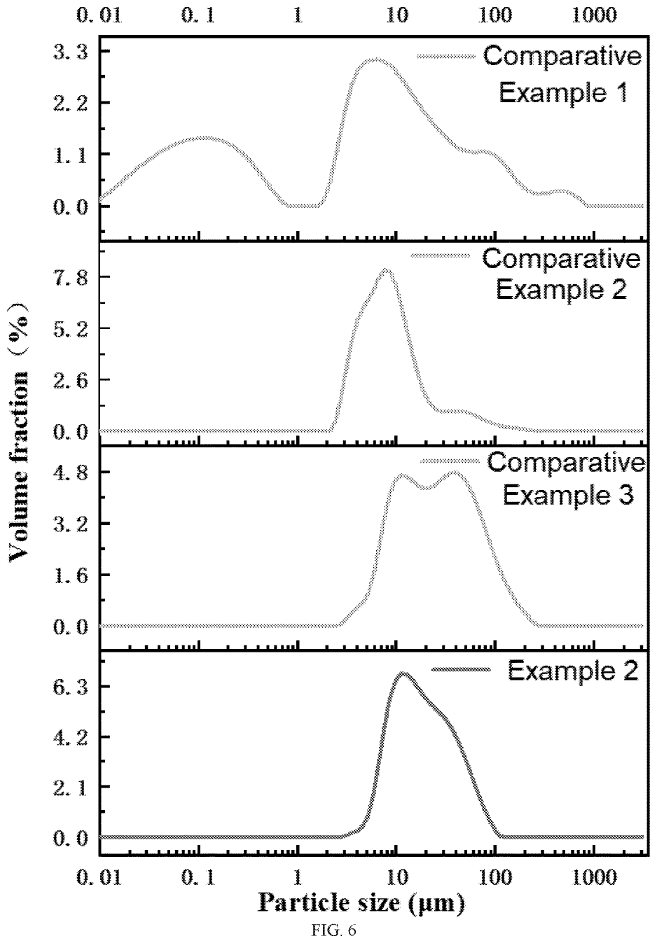

As can be seen from FIGS. 3-6, the rapeseed proteins obtained in Example 2 differ from those in Comparative Examples 1-3 in terms of the structural properties such as surface charge, particle size, and distribution of surface hydrophilic and hydrophobic groups. Comparative Example 1 gives a rapeseed protein obtained by directly adjusting pH of the obtained high-concentration rapeseed protein solution not undergoing any treatments and then freeze-drying, and at this point, the rapeseed protein exhibits a wide particle size distribution, a low surface hydrophobicity, and a low surface charge. Comparative Example 2 gives a rapeseed protein obtained by performing acidic-alkaline-neutral adjustment coupled with ultrasonic treatment on the obtained rapeseed protein extract and then freeze-drying. Compared with Comparative Example 1, under conditions of appropriate alkalinity coupled with ultrasonic treatment, the large aggregates of the high-concentration protein solutions undergo disaggregation; during the process of readjustment back to neutral, factors such as low-concentration salt ions, polyphenols, and pH regulate the protein assembly behavior, resulting in that more charged groups in internal structure of the protein are exposed on the surface, and hydrophobic groups are only slightly exposed, to finally make the protein have increased zeta potential, slightly increased surface hydrophobicity and decreased size. Comparative Example 3 gives a rapeseed protein obtained by performing gradient-acidic to neutral cycle treatment on the obtained rapeseed protein extract and then freeze-drying, where during the process of gradient-acidic to neutral cycle of the rapeseed protein extract, the protein undergoes disaggregation and reassemble into aggregates with large size, and during the reassembly, charged groups on the protein surface are embedded inside the structures of the aggregates, ultimately resulting in a decrease in protein zeta potential and an increase in size. Example 2 gives a rapeseed protein obtained by performing gradient-acidic to neutral cycle coupled with ultrasonic treatment on the obtained rapeseed protein extract and then freeze-drying, where under conditions of acidity coupled with ultrasonic treatment, for the high-concentration protein solution, compared with Comparative Example 3, the large aggregates undergo more intense disaggregation due to the actions such as cavitation and shearing of the ultrasonic treatment; and during the process of readjustment back to neutral, factors such as low-concentration salt ions, polyphenols, and pH regulate the protein assembly process, resulting in that more hydrophobic groups in internal structure of the protein are exposed on the surface, to finally make the protein have increased surface hydrophobicity and decreased size. The above data and corresponding analyses all demonstrate that regulatory principle of the gradient-acidic to neutral cycle coupled with physical field modification technique on protein structure and aggregation behavior is different from those of the gradient-acidic to neutral cycle treatment, and acidic-alkaline-neutral adjustment coupled with ultrasonic modification treatment, thereby causing the proteins to show different foaming properties.

### Experimental Example 3

The colors of the rapeseed proteins obtained in Examples 1-7 and Comparative Examples 1-4 was compared, and the results were as shown in Table 2.

TABLE 2
Colors of Rapeseed Proteins Obtained in
Examples 1-7 and Comparative Examples 1-4

| | L * | a * | b * | WI |
|---|---|---|---|---|
| Comparative | 70.34 ± 0.49 | 4.94 ± 0.03 | 10.23 ± 0.13 | 68.24 ± 0.50 |
| Example 1 | | | | |
| Comparative | 62.59 ± 0.24 | 4.39 ± 0.02 | 8.29 ± 0.11 | 61.43 ± 0.21 |
| Example 2 | | | | |
| Comparative | 69.76 ± 0.30 | 4.50 ± 0.03 | 13.60 ± 0.15 | 66.54 ± 0.23 |
| Example 3 | | | | |
| Comparative | 66.65 ± 0.46 | 4.55 ± 0.01 | 10.16 ± 0.02 | 64.84 ± 0.45 |
| Example 4 | | | | |
| Example 1 | 72.54 ± 0.25 | 4.30 ± 0.03 | 15.84 ± 0.13 | 70.28 ± 0.12 |
| Example 2 | 74.37 ± 0.10 | 5.33 ± 0.04 | 10.52 ± 0.07 | 71.79 ± 0.11 |
| Example 3 | 74.76 ± 0.26 | 5.24 ± 0.02 | 9.90 ± 0.16 | 72.38 ± 0.29 |
| Example 4 | 73.75 ± 0.25 | 4.49 ± 0.02 | 10.88 ± 0.09 | 71.23 ± 0.26 |
| Example 5 | 73.66 ± 0.08 | 5.36 ± 0.03 | 10.08 ± 0.08 | 71.29 ± 0.05 |
| Example 6 | 72.27 ± 0.07 | 5.70 ± 0.01 | 10.50 ± 0.12 | 69.80 ± 0.04 |
| Example 7 | 70.90 ± 0.01 | 4.25 ± 0.06 | 15.05 ± 0.31 | 68.69 ± 0.07 |

WI is the whiteness value, and a higher value thereof indicates a better color of the sample. As can be seen from Table 2, the WI values of the rapeseed proteins prepared in Examples 1-7 are all greater than 68. Comparing Examples 1-7 with Comparative Example 1, it can be seen that the color of the rapeseed protein does not deteriorate after gradient-acidic to neutral cycle coupled with physical field modification treatment, and when the pH and key parameters of the physical field are appropriate, the color of the rapeseed protein is improved, for example, the WI of Example 3 is 72, higher than 68 of Comparative Example 1. As known from comparison of Examples 1-3 and Examples 5-6 with Comparative Example 1 and Comparative Example 3, only when the gradient-acidic to neutral cycle is coupled with physical field for treatment, the color of rapeseed protein can be improved. Example 2 and Comparative Example 2 have the same ultrasonic treatment parameters, and are only different in the pH of the cycle; Examples 6 and Comparative Example 4 have the same infrared treatment parameters and are only different in the pH of the cycle; and Examples 2 and 6 use the gradient-acidic to neutral cycle, while Comparative Examples 2 and 4 use the acidic-alkaline-neutral adjustment. By comparing them with Comparative Example 1, it can be seen that the acidic-alkaline-neutral adjustment coupled with the physical field modification treatment may lead to a deterioration in the color of the rapeseed protein (the WI values of Comparative Examples 2 and 4 are only 61 and 65); and the color of rapeseed protein can be improved only by using the technique in which gradient-acidic to neutral cycle is coupled with physical field modification.

Based on the above analysis, the rapeseed protein prepared by the rapeseed protein preparation process created in the present disclosure meets the European Union standards for edible rapeseed protein in terms of glucosinolate and phytic acid contents; and the present disclosure proposes a groundbreaking “gradient-acidic to neutral” pH cycle treatment coupled with membrane separation and physical field modification technique, and can significantly improve the foaming property of rapeseed protein, and improve the color of rapeseed protein by optimizing the key parameters.

The above description of the disclosed embodiments enables those skilled in the art to realize or use the present disclosure. Various modifications to these embodiments may be apparent to those skilled in the art, and the general principles defined herein may be implemented in other embodiments without departing from the spirit or scope of the present disclosure. Therefore, the present disclosure will not be limited to these embodiments shown herein, but rather will conform to the widest scope consistent with the principles and novel features disclosed herein.

What is claimed is:

1. A preparation method for an edible rapeseed protein with high foaming property, comprising performing “gradient-acidic to neutral” pH cycle treatment on a rapeseed protein extract which is coupled with membrane separation and a physical field modification technique, to achieve structural modification and quality improvement of a high-concentration rapeseed protein.

2. The preparation method according to claim 1, comprising obtaining the rapeseed protein extract by using a technique in which an appropriate-concentration salt solution and directional sieving are synchronously used; then performing primary acidic control coupled with stepwise ultrafiltration concentration to obtain a high-concentration rapeseed protein solution; subsequently, performing secondary acidic control coupled with a physical field treatment; and finally readjusting a pH value of the high-concentration protein solution back to neutral, and freeze-drying to obtain the edible rapeseed protein with high foaming property.

3. The preparation method according to claim 2, wherein a pH range of the primary acidic control is 5.0~7.0, and a pH range of the secondary acidic control is 2.0~4.0.

4. The preparation method according to claim 2, wherein the physical field modification treatment comprises an ultrasonic treatment and an infrared treatment.

5. The preparation method according to claim 4, wherein the ultrasonic treatment has a power density of 10-30 W/mL, and is performed for an ultrasonic treatment time for 10-60 min; and the infrared treatment comprises a short-wave treatment and a medium-wave treatment, and is performed at a temperature of 80-160 °C for an infrared treatment time of 4-16 min.

6. The preparation method according to claim 2, wherein in the technique in which the appropriate-concentration salt solution and directional sieving are synchronously used, the salt solution is a 100 mM calcium chloride or magnesium chloride solution, and a mesh size for the directional sieving is 60-200 mesh.

7. The preparation method according to claim 2, wherein a molecular weight cut-off of a membrane used in the stepwise ultrafiltration concentration is 5-30 kDa, and a protein concentration of the high-concentration rapeseed protein solution is ≥6%.

8. An edible rapeseed protein with high foaming property obtained by the preparation method according to claim 1.

9. A method for using the edible rapeseed protein with high foaming property according to claim 8, comprising using the edible rapeseed protein with high foaming property as a protein ingredient and a foaming agent in food field.
